(19) United States
(12) Patent Application Publication
(10) Pub. No.: US 2011/0112808 A1
(43) Pub. Date: May 12, 2011

(54) INTEGRATED-MODEL MUSCULOSKELETAL THERAPIES

(76) Inventors: Iain Alexander Anderson, Waitakere City (NZ); Robert Farrer Gilmour, Auckland (NZ); Peter John Hunter, Auckland (NZ); Duane Tearaitoa Kingwell Malcolm, Auckland (NZ); Premakumar Mithraratne, Auckland (NZ); Bo Kyung Shim, Auckland (NZ); Martyn Peter Nash, Auckland (NZ); Poul Michael Fonss Nielsen, Auckland (NZ)

(21) Appl. No.: 12/865,557

(22) PCT Filed: Jan. 30, 2009
(86) PCT No.: PCT/NZ2009/000009

§ 371 Date: Jan. 25, 2011

Related U.S. Application Data
(60) Provisional application No. 61/025,856, filed on Feb. 4, 2008.

(51) Int. Cl. G06F 17/10

(52) U.S. Cl. 703/2

(57) ABSTRACT

Anatomical structures such as the musculoskeletal structure of a knee or hip joint, are modeled using a predictive cause-and-effect mathematical model wherein parameters and interactions associated with biological tissues are examined. The model extends over nested small scale parameters (e.g., genetic or cellular) up to macro scale parameters, e.g., body force and motion. The parameter values are populated for a subject or group, and the model is operated iteratively while subjecting the parameters to one or more influences, to project changes over a span of time that encompasses adaptive changes in tissues and also aging and wear.

### BACKGROUND

The invention relates to the assessment and treatment of musculoskeletal conditions, particularly aspects of joints such as the knee joint or hip joint of a human, using an integrated set of computer based mathematical models that characterize constituent tissues and structures and their live interactions. In addition to characterizing the state of tissues at a given time, the models are configured to monitor structural and functional changes, and to project changes that are expected to ensue over time.

The models are nested and connected. Data produced from models that characterize structure, biochemistry and function for one scale or physical relationship are distilled to provide data input to models for other scales and/or physical relationships, both upwardly and downwardly in scale and level of complexity. Solving the models in a given iteration and for a given scale and/or physical relationship, generates values that become inputs in the next iteration. Therefore, iteratively solving the model produces a projection of how parameters are expected to evolve. The solutions are useful for planning and carrying out patient health management by enabling projections to assess options and to aid in decision making regarding therapies and the like.

It is known to characterize or “model” the structures and functions of living beings as mathematical constructs wherein structures such as bones and muscles have attributes such as dimensions, and are engaged with one another at joints that are defined with respect to degrees of freedom permitted by the joints. Force exerted from muscle contraction can be estimated, accounting for leverage. A model might be simple and approximate, or it might be carried into detail in various ways by which the model is refined accurately to mimic a real world living being. In a simple joint model, bones could be regarded as rigid linear structures extending between defined end points at joints. The joints can define limited degrees of freedom (e.g., pivoting on a specific hinge axis for a knee or elbow), or greater degrees (e.g., a universal joint for a hip or shoulder).

As discussed, for example in Blemker et al., “Image-Based Musculoskeletal Modeling,” Journal of Magnetic Resonance Imaging, 25:441-451 (2007), a more detailed model can take into account the actual shape of muscles and bones, tendons and ligaments including their elastic properties, the distribution of connections to bone surfaces, the orientation of striations, etc. Advantageously, information that determines the values of various dimensions and other parameters is available from magnetic resonance imaging, computer assisted tomography data and the like.

Defining and applying a model generally comprises noting and measuring anatomical features from examination of living specimens or cadavers. A set of interactions is surmised from the structures observed. A set of typical parameter values may be recorded, and can be analyzed as to movements and forces that are typically possible. The model can extend to a complete subject such as a human form, or only a musculoskeletal subset, such as a leg or perhaps only a knee joint.

Average or typical parameter values might be used as reference values for use in a model. There may be typical ranges, ratios and relationships found among parameter values for a whole population or a subset that is distinguishable as a class. It is perhaps possible to establish a model based on a reference such as an average or nominal subject. It may be possible instead to assume an ideal subject according to some criteria. But it is not necessary that the model be based on an average or ideal. Another possible model might simply be based on an available example subject that has been examined, or a subject that has one or more aspects in common with the particular subject at issue, or merely a subject that is available and therefore can be a basis for comparison. Accordingly, reference is made herein to a “generic” model, which should be deemed to include any available reference model that can be operatively applied, whether or not the model is an average or ideal or has an attribute such as age or gender or the like in common with the subject at issue. A generic model can be deeds to be simply an available reference that is wholly or partly defined.

To apply the model in an effort to obtain useful information or understanding about a particular living subject, at least some of the corresponding parameter values for the subject are measured. The measured values can be used to adjust the generic model to more nearly represent the actual structures and functions of the subject, resulting in a version of the generic model that is specific to the subject. Parameter values that are not measured may be inferred from expected ratios and relationships. The technique, known as parameter or mesh fitting, produces a model that is specific to the subject, while exploiting information that is known from the generic model. The “mesh” in this context is a mathematical construct based on discrete sampled geometric field of variable values. In connection with physical structures that move, the mesh may be spatial. But the mesh is not limited to spatial variables and coordinates. A relationship of multiple independent variables may be non-spatial, such as chemical or biological effects that suffuse tissues. Variables may be spatial in one sense and non-spatial (e.g., cell function related) in another sense, such as the volume density distribution of available oxygen in muscle tissue.

Models can be simple or can be carried out to extensive levels of refinement. In the case of a joint, the model can involve bone surface configuration and internal mineral density. Muscles can be defined with respect to striations. Neural control of muscles can be incorporated. The modeled information can extend to cartilage that resiliently spaces bones in a joint. The deformability of the cartilage can be considered. The consequent natural play in a joint can be modeled, such as the effect of torque at nominally pivoted joints such as the knee. The dynamic application of forces can be studied, such as forces that occur in the knee joint as a result of the footfalls of a runner.

In an extensive model, sufficient data might be provided to represent pertinent attributes of most or all of the interacting structures that are present. With sufficient computational power, the structures can be assembled in a virtual sense and caused to interact (virtually) with flexion, extension and relative movement, preferably accounting for nonlinearities, anisotropies and the like that are typical of biological tissue. The virtual interaction according to the computations should be an accurate model of the biological specimen and constrained to comport with physical laws, e.g., to stop when portions come into abutment, and not to move beyond points in the range at which real structures would be strained to the point of pain or damage.

Another exemplary publication discussing modeling according the foregoing description is Chao, “Graphic-based musculoskeletal model for biomechanical analyses and animation,” Medical Engineering & Physics 25:201-212 (2003). A standard software application for handling the modeling is discussed in Delp et el., “OpenSim: Open-Source Software to Create and Analyze Dynamic Simulations of Movement,” IEEE Transactions on Biomedical Engineering, Vol. 54, No. 11, p 1940-1950 (2007).

The use of Such modeling is not limited to assessing and analyzing the existing condition of a subject. In Chen et al., “Knee Surgery Assistance: Patient Model Construction, Motion Simulation, and Biomechanical Visualization,” IEEE Transactions on Biomedical Engineering, Vol. 48, No. 9, p 1042-1052 (2001), the particular parameter values defining a patient knee joint are changed virtually to assess how the joint may operate after a proposed surgical intervention. Using this technique, different surgical options can be virtually tested and compared before committing to one.

In Chao et al., “Simulation and Animation of Musculoskeletal Joint System,” Jnl. of Biomechanical Engineering Transactions of ASME, Vol. 115, 562-568 (1993), knee, hip and wrist joints are discussed. The description includes biological structures such as bones and muscles, and also structurally adjacent incremental tissue structures such as segmented areas of cartilage, that are modeled as more or less rigid and resilient structural elements that are connected in tension and/or interposed in compression. The structural tissue elements in this example are muscles and tendons, ligaments, cartilage and bones, the latter potentially reinforced by a surgical implant such as a femoral extension in a hip replacement. The motions of the bones and other associated component parts of the joint can be inferred in much the same way that a civil engineer might model dynamic loads on a building or a bridge.

In a typical joint modeling application such as a knee joint model, the stresses that may be applied to the joint vary with other aspects of the subject. Stress on the knee in walking or running is transferred from the foot and controlled in part by the hip and ankle joints and not only the knee. Various bones, muscles and connective tissue structures in the foot, leg and torso contribute, for example, to walking gait. Events that affect one contributing element will alter the stresses applied to other contributing elements. Therefore, in order to assess the operation of a joint such as the knee, it is useful to consider operation of other musculoskeletal elements. However application of a model, particularly dynamically when assessing gait or the like, can become complicated if one attempts to assess all the contributing musculoskeletal structures.

It would be advantageous to provide an efficient way to handle wide ranging data representing a variety of contributing musculoskeletal elements when applying models to assess gait, to plan surgical interventions. It would also be advantageous to expand the manner in which models and modeling can be exploited, beyond the idea of making virtual changes and testing the results in a simple “what if” comparison of alternatives. A particularly advantageous model would entail a wide variety of biological processes, not only the structural rigidity or resilience of particular tissue structures that can be observed and measured. Accordingly, what is needed is a model that enables a form of feedback, beginning with currently measured or otherwise inferred parameter values affecting biological and biomechanical function, wherein the parameter and variable values evolve over a projected span of modeled time, taking into account the adaptation of tissues as they are subjected, under stress, to positive healing and conditioning (which can be alternatively modeled under different conditions such as alternative implants, different possible pharmacological influences, alternative exercise regimes, selected internal grafts or external braces, slings and supports, etc.). Likewise, taken into account are negative effects such as shock or stress induced tissue compression, aging, abrasive wear of relatively movable surfaces in contact, and so forth. This sort of modeling can span a dimensional scale over a factor of at least 10⁹, from genetic expression to the gross motion of persons or their limbs. The modeling can incorporate genetics, biochemical, neural or vascular function, pharmacological influence, contribution of prosthetic and orthotic supportive and buttressing structures, alternative objectives such as sports conditioning, occupational therapy, and generally provides a way to assess, up to the degree of accuracy and completeness built into nested models, the effects of therapies and other influences on the nature and operation of the musculoskeletal system, and ultimately the subject as a whole.

### SUMMARY

It is an object of the present invention to provide a technique whereby modeling over a range of spatial scales is integrated. Another object is to model over a span of time. The time span is not merely a span that permits visualization of the operative motion of a joint, for example to visualize gait. Advantageously, the modeling is over a longer time span and serves to project how changes in the musculoskeletal system will ensue under different conditions. In the case of a surgical procedure, modeling over spatial and temporal scales enables one to project not only how changes in joint structure at a frozen point in time will affect joint motion, and gait (in the example of a leg joint); such modeling over time also enables projection of how the changes will affect connective tissue, muscles and tendons associated with the joint over a sufficient span to enable assessment of other changes such as the musculoskeletal structure of other joints that cooperate when engaged in some activity (e.g., walking, running, climbing stairs, etc.).

Mechanical loads, mechanical shock, biochemical stresses and other influences are incident on musculoskeletal structures and tissues when involved in daily life. It is a biological function of the muscles, tendons, ligaments, cartilage, bones, etc. to carry these loads. When an influence occurs or changes, the loads and stresses on the musculoskeletal system and adaptation of the tissues to the load produce changes in the tissues. The invention is useful to project such changes over a period of time.

Some pertinent influences affecting the knee joint, for example, could be related to traumatic injury such as sprains and bone breakage. Surgical intervention is an influence. A surgery could be aimed at a direct repair intended to regain an original state, but nevertheless takes time to heal during which reduced function, lack of mobility and pain are influences. Surgery may involve the introduction of a bone implant, graft or similar alteration in the basic structure that influence and can generate changes in other tissues that can be assessed in modeling. Some surgeries involve temporary appliances mounted to permit adjustment of the positions and pressure applied across a joint or parts of broken bones. An ostensibly beneficial influence such as a supportive external brace is an influence that can be modeled. As in the case of modeling to assess the effect of an osteotomy on gait, it is possible by modeling over time to assess the effects of alternative treatments, the application of supportive braces of one kind or another and for a longer or shorter time.

Models at a biochemical or cellular level are defined and applied to provide values for parameters that affect larger biological structures. The larger structures are likewise modeled to provide values for parameters that become inputs at the biochemical or cellular level. The information obtained from the model is useful, for example, to assess the capability of muscles to contract or the rate and locations at which a bone will knit. The stresses applied to a joint, for example due to repetitive exercise, are taken into account when estimating changes in bone density and muscle mass over time. The modeling can be used to assess the effects of influences that are controllable, for example to determine the effects of different amounts or types of exercise, or to compare the effects of pharmaceutical compounds.

An application of the modeling is to plan and manage joint replacements (e.g., hips or knees). The modeling can estimate changes over time during healing or aging, affected by the structure of prosthetics and implants, potential use of restraints and supports such as casts and braces, exercise regimes, pharmaceuticals and similar aspects that are subject to a practitioner's control. An associated application is assessing the potential for loosening of the mechanical connection between prosthetic and natural elements incorporated in the joint, and how altering the influences applied during and after a surgical intervention might deal with this challenge.

On a small scale, biophysical processes from genetic expression to biological and chemical processes, vasculature and neurology affect musculoskeletal function and also changes to the musculoskeletal system when adapting to changes. On a large scale, stress from exercise, possibly affected by other factors such as pathology or body weight, not only affect the musculoskeletal structure but also affect the biological and chemical processes, vasculature and neurology. Thus, influences that are advantageously modeled go up and down in scale, perhaps over a range from one meter down to 10⁻⁹ m and back up again. Accounting for tissue adaptation and healing, appropriate modeling over time is advantageously projected for days, weeks or months. When further modeling for wear, another important consideration with joint replacements, modeling may advantageously carry forward for years and may be expanded to any number of lifestyle related changes that likewise produce influences leading advantageously to tissue adaptation and strength or disadvantageously to loss of gross mechanical function and wear.

Changes to the tissues and their functions are monitored and assessed over time, and projected into the future as estimates that can account for tissue adaptation under influences such as stress and exercise, medical conditions such as diseases, incorporation of grafts or endogenic or exogenic supporting prostheses, etc.

By way of example, the present invention is discussed with respect to the musculoskeletal system and in particular joints that are often the site of injury (e.g., the knee), and influences associated with surgical intervention or repair including introduction of remotely harvested or artificial grafted tissue, healing over time, adaptive rehabilitation with exercise, etc. It should be appreciated, however, that the invention is not limited to these examples and a further object is to provide modeling techniques that can be applied efficiently over a range of complexity, and to various diagnostic, therapeutic, sports training and other situations respecting particular tissues, influences and time frames.

The foregoing objects and other objects are provided by a method for modeling and assessing influences on anatomical structures, including but not limited to the musculoskeletal structure of a knee or hip joint. The model is a predictive cause-and-effect mathematical model wherein parameters and interactions associated with biological tissues are reflected by simultaneous equations. The model preferably extends over nested small scale parameters (e.g., genetic or cellular) wherein the model defined relationships of parameters that produce value used as become inputs for a larger scale aspect of the model. On the large scale side, the parameters extend to macro force and motion values, that are resolved as stresses that can be regarded in the model as influences to which the musculoskeletal structure or other anatomical structures adapt over time.

The parameter values are populated for a subject, and the model is operated iteratively while subjecting the model to one or more influences, to project changes over a span of time that encompasses adaptive changes in tissues and also aging and wear. In various embodiments discussed in detail, the model can be applied to assess injury and healing, surgical intervention with or without the introduction of grafts or prosthetics, application of external braces and supports, exercise regimes, changes in diet, weight and lifestyle, and is generally useful to project biophysical changes into the future. In this context, changes in lifestyle can encompass any difference in environment and situation that operates to influence biological systems. Whether the subject regularly traverses stairs or lives in a ranch style house, the air pressure at the subject's altitude, schedules of sleep and wakefulness, habits (whether good or bad) and various other circumstances influence biological systems and may be deemed aspects of lifestyle. Preferably the model is operated iteratively to project the state of the parameter values over a considerable period of time, sufficient for the musculoskeletal changes to adapt to changes in any applicable influences and but for wear and aging to assume a stable state.

A “parameter” can be deemed to refer to a term in the equations of a model or model component. The parameter has a numerical value that does not change during a given solution of those equations (i.e., during one run of the model), but may be a parameter that evolves and differs from one iterative solution to the next. An example of a parameter might be the viscosity of blood. Such a parameter may vary between individuals, e.g., blood viscosity depends on hematocrit that can vary between individuals. Influences such as medication may vary the parameter over time, for example to thin the blood viscosity, but the change occurs slowly enough that the parameter can be considered a constant during an iteration. Some parameter values do not change at all, such as various physical constants, e.g., gravitational acceleration is constant on the earth, g=9.81 m/s² (although this would be different on the moon). Sometimes a parameter that is constant during the solution of the gait cycle for an individual, can change with disease state or environmental conditions for that individual (e.g. the hematocrit could change with disease or altitude, but it is fixed during the solution of the equations governing the gait cycle). These and similar considerations should be considered when considering the following discussion with respect to “parameters.”

Insofar as parameter values are used in an equation of a component of the model, changeable parameter values may be inputs or outputs. Changeable values that are outputs are “dependent variables,” namely terms in the equations of a model that have a numerical value determined by the solution of the equations. (The value of a dependent variable it is dependent on the solution of the equations and it can vary with time as the model runs.) An example is the stress at a point in the bone during the gait cycle.

An ‘input variable’ is a term in the equations of a model that has a numerical value that is specified before the model is run (i.e., before an iteration of the equations is solved). An example is the initial walking speed of an individual at the beginning of a gait computation. An ‘output variable’ is a term in the equations of a model that has a numerical value that is calculated by running the model (solving the equations). A number of output variables can be combined, for example to represent a measure of the wear on a joint surface after a certain number of gait cycles. It may be just the final value of a dependent variable or it may be a quantity that is calculated from the complete time course of many dependent variables (this is the case with wear).

The present disclosure provides a method for prescriptive and therapeutic health management using subject-specific modeling of an anatomical structure. This method includes establishing a predictive mathematical model having associated parameters and interactions of parameters associated with biological tissues, wherein the model is applicable to predict changes in the biological tissues, expected to result from application of at least one influence, wherein the mathematical model embodies cause and effect relationships among the influence and the tissues. The model is populated with data to define variable values of the parameters, wherein the variable values are specific to at least one of a biological subject and a group of biological subjects. The mathematical model is exercised with respect to defined such influences, and produces an output based on the variable values used as inputs in populating the model and equations that characterize the static and dynamic relationships that are observed or postulated. The output comprises altered values for one or more variable values that are altered as a result of the inputs and influences. The variables produced as outputs by a given component of an overall model can be input parameters to other components whose outputs affect the values of inputs to the given component. Therefore, after establishing a plurality of components for the overall model and giving input conditions and external influences, it is possible to solve the overall model repetitively. After each solution, the model is repopulated with altered values of the variable values obtained as outputs from the previous solution. Iteratively exercising the model to assess results caused by the influence, permits the results of the model to be projected out into the future. The model projects how the modeled subject is expected to respond over time to a given influence or to time changing influences.

In disclosed embodiments, the mathematical model comprises populating or repopulating the model by the input of parameter values on a relatively smaller scale that result in tissue changes on a relatively larger scale. This can involve tissue components contributing to changes in organs, such as modeled adaptive changes in muscle function that contribute to the function of joints, or joint function that contributes to aspects of gait, among other examples. Moreover, the mathematical model advantageously comprises populating or repopulating the model by the input of parameter values on a relatively larger scale that result in changes on a relatively smaller scale. An example is modeling of stress applied at a joint by a regime of physical exercise, possibly further influenced by joint braces, other orthoses or other factors, which is seen by modeling through localized analysis of stress levels, mechano-receptors and the like to predict adaptive localized tissue changes such as the addition of muscle fiber or collagen to muscles, or the localized increase or decrease in bone density caused by application of stress or shielding from stress, respectively. The connections of inputs and outputs of the mathematical model can thus comprise parameter values and tissue effects that range from a micro scale to a macro scale and back, and are connected in various ways by recognized and modeled relationships of cause and effect. Therefore, one or more aspects of the mathematical model concerns assessment of tissue changes that result as a function of at least one of an amplitude of the influence and a duration of the influence that is applied. The influence may be limited to the passage of time. Alternatively or additionally, modeled influences might encompass one or more of natural or induced growth, either as a matter of maturation or healing, physical therapy and exercise, surgical intervention, pharmacological intervention, surgical grafts, implants or introduction of tissue scaffolding, supporting orthotics, disease and pathology, trauma, the associated adaptive and other changes to tissues, and so forth.

In exemplary embodiments, the biological tissues comprise a musculoskeletal structure, modeled to include interactions among at least two of bones, muscles, connective tissues comprising at least one of cartilage, ligaments and tendons, surface defining tissues, introduced materials and externally affixed structures. The modeled anatomical structure can include at least one of cellular, genetic, glandular, cardio-pulmonary, and vascular factors associated with influences associated with at least one of force, stress, motion, exercise, growth and aging.

In connection with some applications such as knee or hip replacements, repair of injuries from sports or accidents, and others, the modeled influence comprises at least one of a surgical intervention, introduction of a pharmaceutical compound, introduction of a tissue scaffolding material, introduction of a structural member, and attachment or engagement of an exterior supportive structure. The modeled effects of the influence can include, among other things, wear on the tissues and change in the interaction with displacement of the tissues, etc. In connection with implants and supports, the effect of the influence may include loosening of engagement of at least one inter-engaged tissues in the anatomical structure and the orthosis with said tissues in the anatomical structure.

The practitioner or technician employing the modeling advantageously runs predictions to test the projected results of altering at least one aspect of the influence and assessing the effect of the influence under altered conditions associated with the at least one aspect. Some influences can be applied selectively or for a selected time or in a selected amplitude or sequence, whereas other influences may be substantially unavoidable. The modeling can be conducted over a longer or shorter term of prediction with more or less detail and in varying degrees of testing of alternatives with respect to influences such as physical exercise, physiotherapy, weight, diet, tissue growth, adjustment of gait and disease state. The invention predicts the expected effects of the influence by integrating said influence over time.

### BRIEF DESCRIPTION OF THE DRAWINGS

There are shown in the drawings embodiments of the invention as presently preferred. The invention is not limited to the embodiments shown and specifically described. Nevertheless, these embodiments illustrate practical applications demonstrating exemplary applications of the invention both generally and with regard to specific applications. In the drawings,

FIG. 1 is a flowchart demonstrating aspects of the inventive modeling techniques, integrated with a system for managing general and subject-specific data.

FIG. 2 is a functional flowchart illustrating development of models comprising coupled component models.

FIG. 3 is a functional flowchart demonstrating the iterative operation of a model over incremental time periods, wherein the output variable values produced by a component model are at least partly fed-back as input variable values to the same or another component, so as to influence the solution of a subsequent iteration.

FIG. 4 provides an explanation of host-mesh fitting.

FIG. 5 is a flowchart showing the circular or feedback nature of information according to the invention, wherein a starting state is defined and alterations result from potentially variable or discontinuously applied influences during each solution and produce effects carried forward in subsequent iterations.

FIG. 6 is a diagram showing the nested nature of modeling of contributing biological components of smaller and larger scale according to the invention.

FIG. 7 is a flow diagram illustrating specific application of the invention to bone density modeling, for example in a total knee replacement scenario.

### DETAILED DESCRIPTION

The subject method involves modeling the functioning and changing of anatomical and biological structures and functions, using plural interconnected component models to represent biological systems. The component models have inputs and outputs that are coupled to one another, such that outputs of some component models are inputs to other component models, including on a smaller or larger scale in the biological system, or on a comparable scale.

Values of component model outputs are a function of the values of the inputs to that component model. In addition to the inputs that are the values of the outputs of other models, the inputs to a component model include fixed or variable conditions and external influences. Therefore, one can apply selectably changeable conditions or influences, and by operating the model, estimate the effects that are expected to ensue.

According to the method, beginning with a set of interconnected component models and parameters values defining a starting state, the component models are solved. That is, output values are calculated as a function of the input values according to a cause and effect relationship represented by each component model. The component models are solved iteratively and repetitively. Inasmuch as the component models are interconnected by outputs to inputs, changes propagate through the component models. With successively repeated solutions, the model represents how the function and structures of the biological system are expected to change.

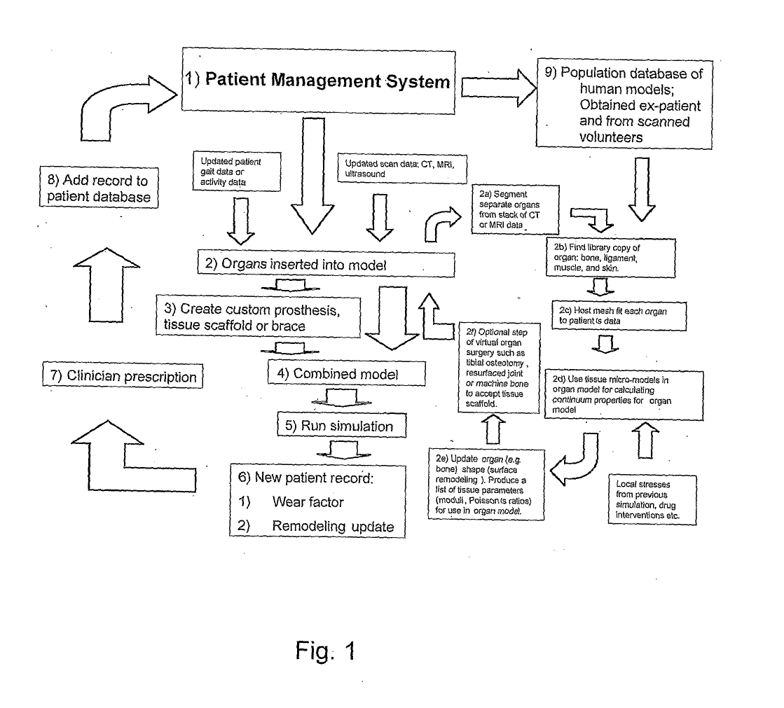

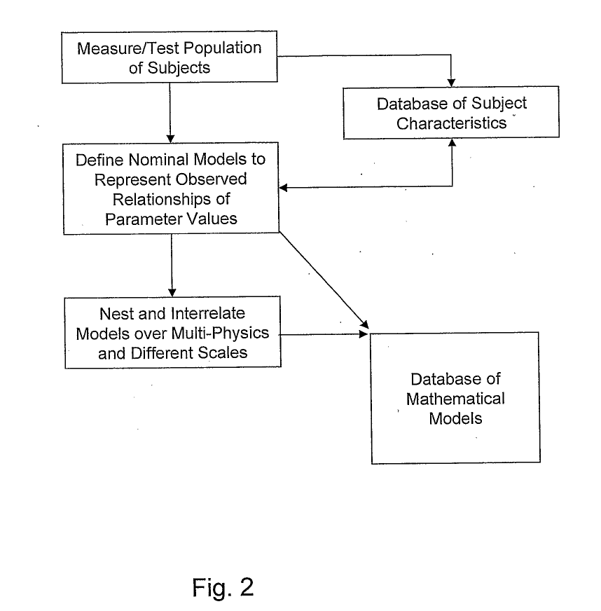

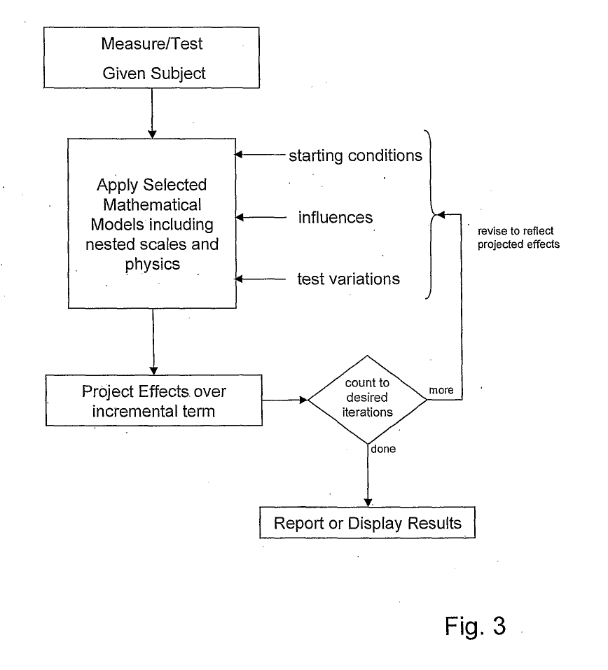

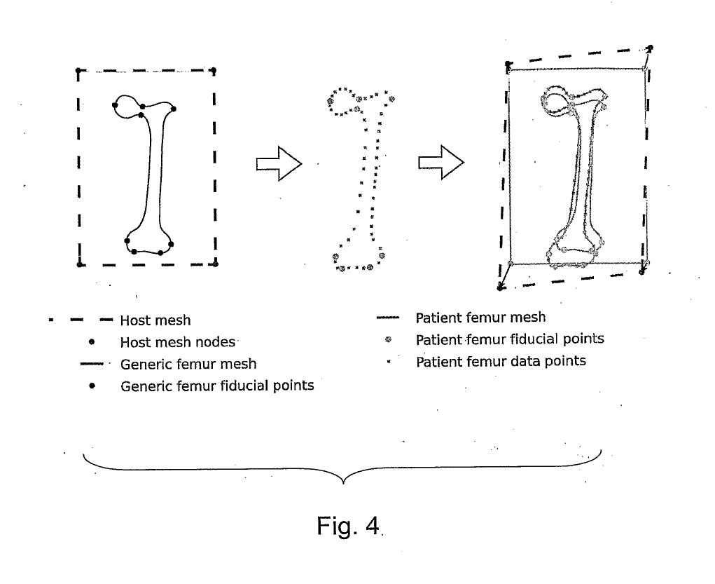

FIG. 1 is a flowchart showing how this method can be embodied in a patient management system. FIG. 2 shows how accumulated modeling data associated with patients can populate a database wherein the characteristics of subjects are associated with parameter values so that models that are generic to classes of subject are developed. In this context, the “subject” might be a medical patient if the interest is therapeutic, an athlete if modeling sports, an employee when modeling ergonomics, a customer when modeling a useful product, etc. With the benefit of a generic model, information can be inferred with statistical probability as to subjects that are considered to fit into particular classes. FIG. 3 illustrates the incremental solution of a model wherein the output values developed in one iterative solution affect the input values of the next iteration. FIG. 4 shows how a generic mesh is host-mesh fitted to the subject's measured data in order to obtain a subject-specific model.

Model components can have many inputs and many outputs that couple different biological systems. Considering just two components and one connection (assuming other things are equal), a first model component produces at least one output value, based on a transfer characteristic of the first model component and the present values of inputs to that component. The output value is an input parameter value of a second related model component, the second component defining relationships that depend at least partly on the parameter values that were output from the first model component. The models provide nested cause and effect relationships and are solved for one time increment, producing new output and input values, and then solved for the next time increment. At least some of the variable values that result from the solution alter the starting state or input values applicable during the next iteration. The models are then solved again for the altered starting state and a next increment in time, proceeding iteratively. During this process, one can apply and optionally also vary internal or external influences to determine the estimated results of such influences. Solving the models iteratively in this way provides an assessment of how the anatomical and biological structures are likely to function and change over time.

The invention is exemplified by a method for assessing changes in the structures, like mass, fiber angle or density, of bones, connective tissues and muscles. By altering the nature of influences on the modeling, such as the starting conditions and the internal and external influences, and altering the time and duration of such influences, the progress of tissue adaptation (e.g., growth and conditioning) and tissue degradation (aging and wear) can be assessed. The models are nested and connected such that parameters that emerge as solutions to the model for one scale or physical phenomenon are fed back as inputs at another scale or physical phenomenon. By way of example from larger to smaller scale phenomena, muscular activity during exercise produces gross mechanical stress that affects tissue structure, such as bone reformation or muscular conditioning. Such reformation or conditioning produces effects (outputs of the model) that are input conditions in the next iteration. Likewise from smaller to larger scale, the effects of respiration, circulation, metabolism and the like on the cellular level affect the tension that a muscle can exert and the amount of work that that the muscle can accomplish in a given time period. Over a projected future, the expected evolving state of the parameter values can be monitored and assessed. Such assessments are accurate to the extent that the models are accurate, and may diverge from actual results after a time in the same way that prognoses as to the weather become increasingly speculative for longer times into the future. However the models provide useful projections, and furthermore can be refined and adjusted by comparing their projected results to actual results, and modifying the models where necessary.

Beneficial tissue adaptation to be assessed can include, without limitation, healing after a surgical intervention such as a joint replacement, development of muscle mass, strength conditioning, weight loss, etc. The technique also can be used to assess adverse effects such as tissue damage, wear, aging, atrophy, infection and the like. In general, the invention enables a projection (for comparison or otherwise) based on wide ranging input data as to how particular starting conditions and subsequent influences can be expected to provide beneficial or adverse outcomes in one way or another. Among other examples, modeling with different starting conditions and different influences entails setting up a customized version of a generic bio-model embodied in mathematical relationships, and observing changes to be expected over time.

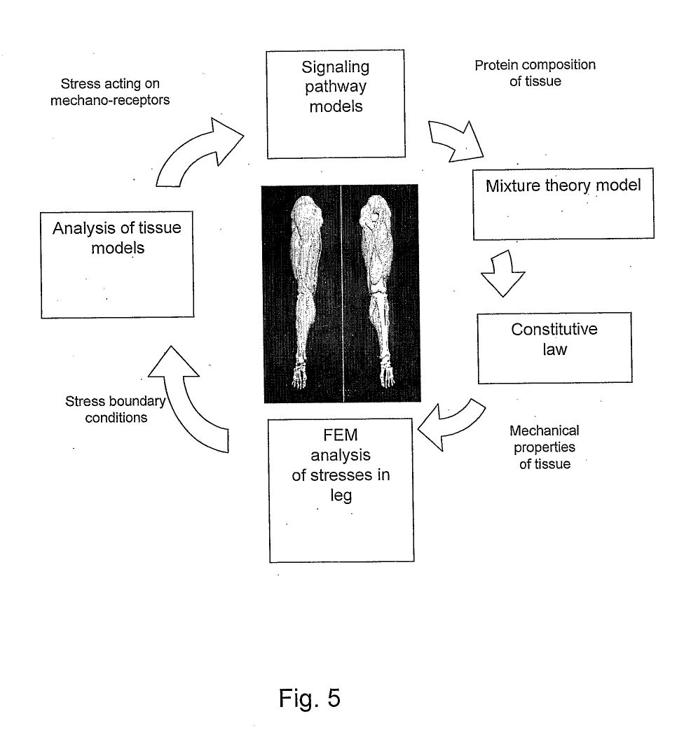

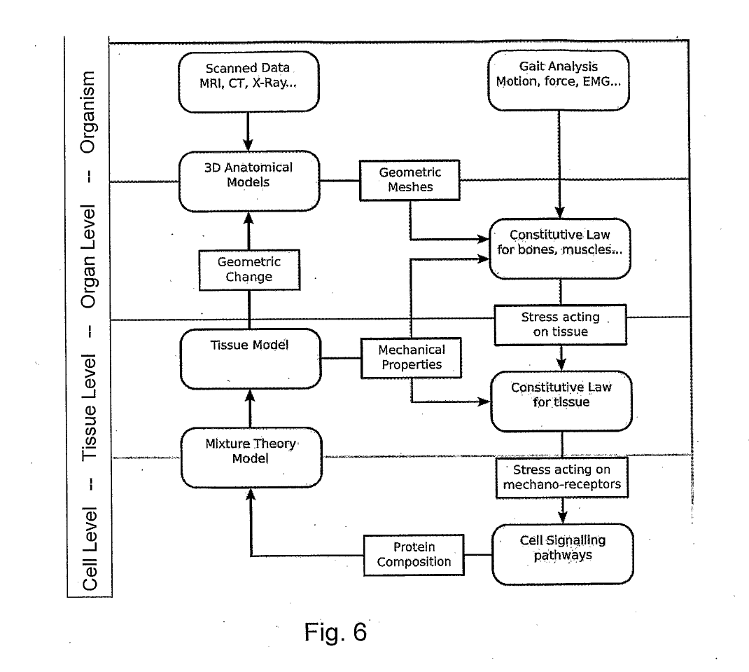

FIGS. 5 and 6 demonstrate examples of a generic bio-model. In one embodiment, raw data on a subject, which is to be used for image segmentation and model fitting algorithms, can be obtained from medical imaging scans (e.g., MRI, CT, X-ray, ultrasound, body surface scanners, etc.) or from physical measurements such as size and/or weight. From scanned images, specific geometric (morphological) details of body surfaces, such as the configurations of bones, muscles, etc., may be obtained. The data are not limited to static imaging. Gait and similar active movement data can be collected from which relative positions and times reveal kinematics and forces. At a macro organism level, the kinematics and forces are used to predict joint forces. Using the knee as an example applied as in FIG. 6, the joint forces are outputs from an organism level model. These outputs (joint forces) are inputs to a localized model of the knee joint, which can be considered an organ level model. The forces act as variable values or input conditions to the organ level knee model. The resulting outputs are stress and strain variable values in the bones, muscles, connective tissues and cartilage. These stress and strain output values then are used, for example, as inputs to a tissue level model of the bone. The bone microstructure (assumed from density measurements from CT scans) and material properties at the tissue level can be taken into account in the model, including local difference in density, orientation and striations, etc. Taking into account the bone microstructure enables the stresses and strains to be modeled as they occur at the microstructure level (the tissue level). The stress and strain values are inputs to a cell level model, by which mechano-sensing pathways cause to the cell to increase or decrease the expression of proteins as a function of the level of applied stress. The output of this cell level model represents a concentration of protein expression. The concentration is an input to a mixture theory model, that predicts the influence of the proteins on the tissue, i.e., a representation of how proteins lead to changes in tissue structure, including changes in the mechanical (or material) properties of the tissue and also the geometry of the tissue. So the outputs of the tissue model are mechanical properties and updated geometric models.

These changes are among the inputs and/or the starting conditions used in the next iterative solution of the coupled model components. In summary, the changes produced in the microstructure and macrostructure of the bone are estimated using the coupled model components. During the next iteration, the bone configurations are defined to include the changes that were made in the earlier solution. This loop is repeated over many iterations, each iteration representing some unit of time: The overall result is to predict the changes that can be expected over time in the modeled bone structure, subject to the forces produced by the gait.

The method is useful to estimate the results of conditions that might be changed. Examples are modeling (as described above) while factoring in the additional effects of a proposed change in conditions. Examples are to add the effects of: a particular drug or dosage or combination; the additional support of an orthosis; an external brace for the knee or the like having some specific structure to be compared against a different possible structure or mode of attachment; or an implant; or a therapeutic or developmental regime of exercise (among other examples). Operating the models predicts the change over time of these introduced influences.

It is possible to operate more or less extensive component models by using more or fewer biophysical components in the entire model. In this way, a more extensive model may take into account jointed link mechanics, elasticity, reaction-diffusion, cellular-kinetics, and so on. Depending on the objects, it may be appropriate to include blood perfusion in assessing pharmaceuticals. Muscle action can be modeled for its effects on circulation so as to increase perfusion to the region and change the way that tissues take up nutrients. Muscle action can be modeled with respect to the extent of excitation-contraction to take into account more or less energetic forms of exercise.

A generic model approximating a typical subject or class of subjects can be customized according to the invention by adjusting parameter values based on measurements of the subject, and altering the modeled relationships to reflect those of the subject. Applicable measurements can include, for example, dimension and shape measurements using imaging or direct measurement, biochemical assessments derived wholly or partly from body fluids or tissue samples, functional assessment of neural, vascular, muscle, skin or other organic or tissue functions, for example during dynamic stress testing and so forth. Insofar as the data is incomplete, the aspects of the generic model can be assumed tentatively. Determining and at times selecting starting conditions and influences may involve determining the subject's status with respect to any pertinent medical conditions, occupational needs, general demographics such as age, gender, height, weight, body mass index, etc., then selecting among alternative interventions: surgical procedures; choosing whether and/or how long and with what structure to immobilize the subject, e.g., to hold a joint in a cast or brace; planning alternative diets or pharmacological intervention at particular times and for particular duration, more or less aggressive exercise regimes and generally any or all inherent and exterior effects that are pertinent, especially to tissue growth or degradation, adaptation to stress and exercise, wear and changes in fit or loosening of prosthetics.

The invention is discussed with respect to the nonlimiting examples of anatomical structures such as the musculoskeletal structure of a knee or hip joint. The invention is also applicable to other limbs and joints such as the shoulder, and to joints and structures that are not associated with limbs and appendages, such as the vertebrae. The pertinent structures are not limited to the bones and muscles, and include associated vasculature, connective tissues, interposed cartilage, neural function and any other anatomical and physiological function subject to characterization by modeling.

FIG. 1 illustrates an overall arrangement of activities and data flow paths associated with establishing and operating a method for prescriptive and therapeutic health management using patient-specific modeling of an anatomical structure, according to the invention. FIG. 2 generally shows establishing a model by collecting and analyzing data to establish a predictive mathematical model having associated parameters and interactions of parameters associated with biological tissues, wherein the model is applicable to predict changes in the biological tissues expected to result from application at least one influence, wherein the mathematical model embodies cause and effect relationships among the influence and the tissues. This is accomplished by establishing a set of relationships that reflect the input-to-output relationship between causal parameters. (inputs) and resulting parameters (outputs) that vary with variation of the causal parameters. The relationships can be a set of simultaneous equations. At least some of the relationships are such that the resulting parameters (outputs) are modeled by integrating the causal parameters over a period of time and/or by determining the rate of change of the causal parameters (differentiating the causal parameters versus time). It is also possible to employ constant values or to apply values that may be changeable parameters but are assumed to be either a constant value (for example because the parameter changes slowly relative to the time scale to be modeled), or a time changing function that is expected to persist (e.g., cycles of sleeping and wakefulness. The input parameters to the model components are applied or assumed. The outputs of certain model components are fed back as inputs into other module components, thus populating a model with data to define variable values of the parameters.

FIG. 3 shows how the model is exercised to predict the results of a defined influence, and producing an output from the mathematical model based on the variable values used in populating the model. In a given iteration or solution, the output comprises altered values for one or more of the variable values of the parameters as a result of the influence. According to an inventive aspect, the results that are produced from an iteration are fed back as starting conditions that affect subsequent iterations, namely by repopulating the model with the altered values of the variable values and again exercising the model to assess results caused by the influence.

The “model” for a subject comprises a programmed collection of cause-and-effect relationships. According to the relationships defined mathematically in the model, the values of one or more parameters are input, at least some of which values concern independent variable parameters that can be measured for one or more subjects. The mathematically defined relationships are solved iteratively to produce output variable values that represent changes that are predicted to ensue for the subject. According to an inventive aspect, at least some of the output variable values that are solved in a given iteration are input variable values for a next iteration (or are employed to alter other input variable values for said next iteration). According to another aspect, the output variable values produced in a given iteration by a model component that concerns a particular physical phenomenon and/or a phenomenon on a particular dimensional scale, become input variable values for other physical phenomena and other scales, thus connecting the model components into a representation of an interactive group of phenomena.

Ideally, the scales and physics that are connected in this way take complete and accurate account of the biophysical structures and functions of the subjects. If inaccuracies identified by comparing subsequent measurements of actual subject parameter values to the values that were predicted by the model do ensue, either the parameter values can be adjusted to recalibrate the calculations, or preferably, the modeled mathematical relationships are refined to more accurately match the predictions produced from the connected model components, with actual experience, possibly by applying additional component models that account for the differences between the results produced by the model and observed results in the subject over time.

If one determines that there are inaccuracies in the outputs produced using a model, it is possible to improve the results in several ways. One example is to analyze the sensitivity of the outputs to variance in the different input parameters used by the model. For example, assuming that ground forces are inputs to the model and it appears that there is some error in the accuracy of modeled forces based on ground forces (among other input variables), it is possible to perturb the inputs to the model by a small amount, to then re-run the model, and to assess the relative influence of the input variable on the outcome produced by the model. If the influence of a variable such as ground force value is found to be large, then additional attention can be devoted to obtaining more accurate input data measurements of the ground forces.

In a simplified hypothetical example, one might model a regime for recovery for a sports figure who has suffered a broken bone in the foot. It may be observed that physical exercise has an effect on bone density due to the adaptation of bone tissue to mechanical stress as a function of time. It may also be observed that the patient has gained weight and lost muscle tone during an initial period of inactivity needed to recover from the injury. A circulatory and muscular conditioning regime could be planned, involving walking, jogging and running. The model is used to estimate the effects on healing of the broken bone using a longer or shorter term at one or another of the exercise levels. The model also can be used to estimate other effects such as change in body weight, as affected by a particular caloric intake, or by varying the caloric intake.

A collection of software and certain models for assessing biological subsystems such as muscles and bones, for example including subsystems such as models for measuring bones, muscles and connective tissues for analyzing walking gait, has been developed and continues to be developed in a web-accessible XML database of anatomy and material properties for the human musculoskeletal system, by the University of Auckland, NZ. (XML or “extensible markup language” refers to an information coding technique permitting authors or developers to establish labels and tags that are defined within their particular applications.) This effort has included development of nominal constitutive laws based on tissue structure for the components of the human knee that contribute to its mechanical function. The models have been developed in part using MRI and other medical imaging to obtain subject-specific information on anatomical features. A “constitutive” law is an empirically determined relationship between stress and strain that characterizes the properties of a material such as bone or muscle. Some parameters of a constitutive law can be derived from knowledge of the tissue microstructure or from measurement.

By collecting information on many subjects, a growing database of human subjects provides a statistically pertinent volume of information that can be referenced. Using a generic model as the reference subject, it is possible to infer and/or identify mathematical relationships between the values of different parameters by which subjects may be measured. For example, if we have the age, gender, height and weight of a person, we can estimate likely characteristics of that person's skeleton by comparing the person with the generic model, and also comparatively comparing other instances from a population or a sub-population from the database against the generic model. This enables attributes of sub-populations to be compared or distinguished, estimated an inferred as likely or unlikely, whether the generic model happens to be closely similar to the person or not.

A collected set of these relationships form a model that is employed by defining or assuming, measuring, altering, adjusting, predicting or otherwise providing a sufficient set of parameter values, to be used as inputs to the mathematical relationships, so that other parameter values can be determined as outputs, namely by solving mathematical relationships that define the model.

A particular technique that is useful in connection with variables that concern size, shape, motion and similar spatially related parameters is “mesh fitting” to relate parameter values of a specific person (a subject), such as the size and shape of certain tissue structures of the specific person, against those of the generic model subject. The differences between observed or measured attributes of the person (parameter values), versus corresponding attributes of the generic model, are determined and encoded and provide an efficient way to customize the components of a model, developed for the generic model subject, so as to generate customized relationships that are accurate for the specific subject person. It should be noted, however, that the concept of a generic model subject does not exclude the possibility that the generic model in Use may be a member of an identifiable class of subjects. For example, an “adult female” model may be defined to be distinct from other ages and genders. Models can be defined for subjects in other classes as well, such as subjects affected by a particular pathology. For example, if a youth with cerebral palsy is found to have a distinct pelvic geometry, a new model class can be established from measurements taken from CT data on the patient. Again, the technique of fitting measured or observed attributes for a particular subject versus those of a generic model subject does not require any particular sort of generic subject and is not limited to encoding for size and shape, but also provides a technique by which other complex or multidimensional aspects of a particular subject can be compared against the generic subject forming the reference to be fitted to the specific subject.

A complete model can comprise geometric models (such as meshes that describe shape and store parameters, e.g., the density of bones, the nature and orientation of muscle striations and the like), and functional models. The functional models describe how the geometric modeled structures move (kinematics), interact (contact mechanics) and/or change over time, leading to updating and remodeling at cellular and tissue levels that are coupled according to the model components. The primary aims of geometric models or meshes is to describe shape and associated parameter fields, e.g., material properties like bone density. There are differences between subjects and differences between the subject and the generic model subject. The differences can be associated with other characteristics of the subject or of the population from which the generic model was derived, such as the gender and age of the subject or subjects. These meshes can be compared, cataloged according to the characteristics and often correlated with values of the characteristics. The meshes also interact and change over time according to laws of physics which are represented using equations, etc.

A store of knowledge is collected that is consistent with the biological relationships that characterize subjects, for example demonstrating how a range of joints of persons with different attributes (different parameter values) have been observed to function and to achieve different results, such as capabilities. With pragmatic understanding of the biochemistry and biomechanics involved, the relationships of the values for a set of input parameters to a mathematical model, using mathematical cause-and-effect functions, are proposed to explain the observed relationship of input and output parameter values, and then tested and proven in practice. Outputs parameter values for a new subject applied to the mathematical model, are at least suggestive and often are accurate to characterize the function of the specific new subject. In short, by developing cause and effect models based on input parameter values, the values of output variables associated with biomechanical functions and also biological tissue structure (e.g., as affected by healing and exercise conditioning) can be predicted. Combinations of these outputs may be used to generate a numerical value or index representing a prognostic or diagnostic indicator.

The University of Auckland, NZ has developed a database of over 300 models that have components relating to aspects of cell function, such as metabolic pathways, ion channel electrophysiology, signal transduction pathways and material constitutive laws for biological tissue. These models are encoded in an XML language called CellML. An associated XML markup language for spatially distributed properties (FieldML) has been developed and a database of anatomical models has also been established for the musculoskeletal system, which includes anatomically detailed models of most or all of the bones and muscles of the human body. A collaborative website for this material currently exists at www.cellml.org.

Among other biological structures, the components of the leg relevant to mechanical function (bones, muscles, tendons, ligaments and cartilage) are included in these models. The parameter values for a given subject are inputs; the subjects parameter values are fitted to customize the results produced by generic model components mathematically to represent the given subject; and the equations that are incorporated in the model components are solved to generate output variable values.

“Mesh fitting” can denote fitting a generic mesh to measured data from a real subject. The measured data can be segmented from MRI or CT scans. The encoded output of a mesh for a subject can identify a set of data points corresponding to point locations falling on the surface of an anatomical item, such as points on the outer surface of a bone. A generic mesh is derived for that type of bone. The values of the generic mesh are modified to minimize the difference between the surface of the generic mesh and cloud of data points segmented from the subjects scans. When the difference is minimized, the generic mesh is assumed to be representative of the subject and is taken to be the subject specific mesh.

In addition to mesh fitting the locations of surfaces, other variable values can be treated in a similar way. For example, local bone density values can be segmented from a CT scan, and the local density values are stored in association with corresponding positions within the volume of the bone. Modulus and strength data can be derived from the CT scan of a subject's bone by obtaining a CT scan of the bone, wherein the CT scan is calibrated by scanning a phantom in the scanner, such as a bone mineral block of known density. The local bone density from point to point in the scan of the bone is encoded, by relating it to CT number. Mechanical characteristics are derived from the bone structure and local variations in bone density. For example, regression equations relating density to mechanical properties are discussed in J. Y. Rho, M. C. Hobatho and R. B. Ashman, Relations of mechanical properties to density and CT numbers in human bone. Medical Engineering and Physics, vol. 17 (1995), pp. 347-355. Rho et al. measured mechanical properties and density data on human bone from several locations including the spine and femur and calculated regression equations for calculating mechanical properties.

The model components are related to one another in that output variable values from certain components predict parameter values that are input variable values to other components. Therefore, the solved output variable values from an initial solution to the equations defining one or more of model components can be used in a subsequent iterative solution of the overall model to predict the variable values as the input and output variable values evolve over time and/or in successive iterations wherein the models are solved.

The cause and effect relationships that are embodied in the model components can connect both upwardly and downwardly in spatial scale over a collection of model components on the level of genetic or biochemical reactions, characterizations of cell and tissue function, the configuration, size and shape of organs, the operations thereby made possible for collections of cooperative organs, the stresses and wear that are applied from force and motion, and back again in a next iteration. The next and subsequent iterations encompass the effects of stress on the structure and function of tissue at the biochemical or cell level, leading to adaptive tissue changes that affect stresses and so forth. In the case of the knee, for example, CT, MRI and/or gait data provide subject-specific information for modeling of the knee. Joint forces are assessed that act on the tissue around the knee. The forces are coupled as stresses in the structurally defined bones and muscles. Mechano-receptors at the cell level lead to expression of proteins as a function of such influences. The tissue properties and shape, as modeled, are seen to change incrementally over an incremental time. These changes dictate adjustments in the structural definition of the bones and muscles as modeled. Over repeated iterations, the effects are assessed, and by running the model under varied conditions, the effects of the varied conditions can be compared.

Accordingly, the model components representing biological structures and functions are “nested” and connected by input-output-input variable relationships. The outputs of certain models produce variable values that are inputs to other models (or at least are factored in, and affect the inputs to other models). According to the foregoing description, models for smaller anatomical aspects may feed input data to models of larger anatomical aspects. Models for larger anatomical features also produce input data to models of smaller features, for example by applying stress. Apart from size, models that define cause and effect relationships in genetics, microbiology, circulation, neurology all can provide influences on one another for which account is taken by connection of their models of cause and effect.

The models preferably are solved repetitively and/or iteratively. Conditions used as original input values can change over time for different reasons, and produce changes that trickle through the sequence of input-output-input variable relationships. Variable effects can be integrated over time, for example using the Euler method or the Runge-Kutta method. The coupling of variable values between model components can be weighted to fine tune operation of the model. Where pertinent, the rate of change of variable values can be taken into account.

In the present invention, models that are solved to represent aspects at a given point in time (which models may be for larger and/or small anatomical elements) also produce variable values that are used in feedback relationships to affect the inputs to models (which may be larger or smaller) in subsequent iterations of solution. In these relationships, successive iterative solutions predict how output variables change over time. According to another aspect, the influences that are applied to the model can be changed according to arbitrary changes of external influences that are input by operator choice, to test the effects of changed influence. In some instances, changing influences are planned. For example, a surgical intervention such as a knee replacement may be modeled to account for the surgical changes to structure, expected healing, a knee brace or to be worn for a prescribed time, and a progressive exercise program. The changing influences can be altered to test their effects. Among other possible software applications, combinations of different surgical, orthotic and rehabilitative therapies can be compared automatically, with the software providing an optimal choice among all the alternatives offered, and an optimal schedule of therapies as predicted to produce the most favorable end result.

The model components can be considered sets of inter-related equations. The inputs, outputs and transfer functions can be determined empirically or by detailed analysis of phenomena and interactions. Certain relationships are well defined. For fluid mechanics, for example, Navier-Stokes relationships related to conservation of mass, momentum and energy and can be embodied in the equations. There are many modifications of these and similar equations for specific situations, for example, Stokes flow and Poiseulle flow. Finite elasticity equations also are known for mechanics and reaction-diffusion equations for the transport of particles. At the cell level, an exemplary relationship is defined by the Michalis-Menten equation. Other cell kinetics can be represented by equations fitted to empirical data. A number of exemplary models are currently available at the CellML repository (http://www.cellml.org/models), including models at the cell level and also at the tissue level for mechanics.

The effects of various input conditions and applied influences can be modeled and observed in a projection of the future. During the projection, for example, the anatomical elements can be virtually exercised, anatomical tissues adapt to stress in a virtual sense, the effects of virtual braces can be examined for a selected time interval, prostheses can be predicted to become tight or loose as tissues adapt, and in general, natural adaptation of the subject is predicted over time, preferably in response to selected or changeable influences that are likewise input variables to the model components.

In an example, cellular models may be affected by input parameter values involving blood circulation, neural stimulation, stress and exercise. These models may generate variable values such as protein production by gene expression at a small scale, tissue growth, strength conditioning and vascular adaptation. Models involving particular muscles contribute to the operation of a joint. Models of several joints contribute to cooperative motion such as a model detailing the operation of a joint such as the knee or hip.

Among other applications for the models, bone density changes can be monitored and managed when an implant is to be placed in the body. Cartilage damage can be monitored and managed when considering or designing a knee brace or orthotic, or in connection with losing weight. In these instances, pertinent information is available using modeling that starts at the whole organism level, including the motion of the person, this can be described by measured kinematics. The activation of muscles can be measured and used in the models to improve the prediction of motion and joint forces. The common aspects are the basic modeling, physics, techniques and frameworks, e.g., finite elements and multi-scale modeling. The modeling inputs are varied in different applications by imposing conditions that are subject to change, such as the application of a knee brace or orthotic, a different configuration of an implant, a change in the subject's weight, a difference in the nature and/or timing of exercise, etc. In addition to difference based on imposing changeable conditions, the models produce different results for different subjects because the models incorporate differences in the sizes and shapes (e.g., as encoded by measured and fitted meshes), material parameters, kinematics, and body forces that characterize each subject (or perhaps each generic class of subjects).

A generic model is defined, and represents the relationships of the model (or nested related models) when populated with parameter and variable values that are considered representative of all subjects or representative of an identified class of subjects. Measured values for a specific individual person (or a subset of some group) may vary from the norm, namely when the individual has parameters (such as sizes, proportions, genetic or biochemical activity, etc.) that differs from the norm. As a result, when the parameter values are plugged into the relationships of the model (or nested related models), output variables likewise differ from the norm. It is possible in this way to estimate and assess how an individual may differ from the norm in various respects that emerge as variable values when the models and their relationships are solved. It may be difficult to compare an individual versus the norm using MRI or CT scans alone, even though data from the scans can be segmented and can characterize the subject (or the norm) in detail. However, if meshes are fitted from a mesh norm to the segmented data of one or more subjects, it is more readily possible to compare two individuals and also to assess differences between two subjects or between a subject and the norm, according to a common frame of reference, namely the norm and fitted meshes.

The relationships may comprise a set of simultaneous equations that include linear and/or nonlinear relationships of particular parameters that when solved produce outputs in the form of variable values. The relationships can include Boolean logic, thresholds, if/then situations and the like. The relationships preferably include those of finite elements that contribute to a function such as the vectors for motion and acceleration and the displacement of a joint. Some of the relationships can be numeric and based on algebra, calculus and/or differential relationships and integrals. The relationships of parameters, embodied in the equations of the model, can include some relationships that are well understood or proven to some level of precision or confidence, but certainty is not absolutely necessary. Some of the relationships alternatively might be logically inferred or perhaps only hypothesized or suspected, for example because mathematical correlations may have been observed. These relationships can take probability into account, especially when dealing with individuals that are members of some group for which statistical information is available. Similarly, the relationships might be known to be sustained relationships or they may be temporary and based on a current state of other variables. Any such certainty or uncertainty that is embodied in the model may affect the extent to which the model corresponds to actual experience. It is advantageous if the model is highly accurate, but a model also can be useful even if its accuracy is approximate or only dependable over a certain span of time.

In the context of this disclosure, ‘cause and effect’ should be deemed to refer to actual or projected relationships between one more outcome values or ranges of values versus a combination of input data values. The output outcome values are obtained by solution of equations that relate or attempt to relate input and output values according to scientific laws that govern the behavior of material objects such as the muscles and bones of the knee or other joints. These laws are the result of chemical, biological, electrical, mechanical and other physical phenomena, insofar as understood or observed. Therefore, the model comprises a mathematical set of rules for predicting (knowing or estimating by inference) from input parameter values, the values of other parameters and interactions associated with biological tissues.

Modeling is possible in different levels of detail. For example, a muscle could theoretically be modeled to the level of individual cells or grouped cells, of given size and material characteristics, capable of contraction according to particular parameters. This level of detail may be unnecessary in some applications. Alternatively, information that might be determined in a detailed analysis of muscle cell performance can be distilled to a more coarse level of detail, for example in order to characterize muscles or other groups of cells as mechanical members. An example is using an array of contractible elastic strings to model a muscle. In this example, the strings have models concerning activation, contraction and line of force. String models are simpler than full 3D models of muscles with detailed analysis of muscle fiber orientation, activation by neural action, and contraction. Likewise, in some instances, it is sufficient to model bones as articulated mechanical members. In coupling together and solving component models, it is advantageous to model bones on two levels, using articulated mechanical member characterizations for some modeled simulations and using finite element models when more accuracy is needed, for example on a cellular level. As an example, when modeling to assess damage to cartilage in the knee and forces applied to bones at the knee, one might use mechanical members for modeling during the swing phase of the gate when there is not much force acting on the knee joint. When the foot strikes the ground, one could extend the modeling to finite element models, for accurate analysis of the distribution of forces. Similarly, modeling the knee, it may be appropriate to model the bones and connective tissue adjacent to the knee using finite element models and to model remote bones and tissues as mechanical members.

The values of the parameters vary for different subjects. The subjects must be fitted into the model in order to provide input values of the parameters for that subject. The model might be designed to apply to all subjects. However it is also possible to provide models that are applicable to or most accurately associated with a particular class of subjects. For example, a different model may be appropriate to predict information respecting an adult versus a child, unless age or growth maturity is a factor that is already built in.

The “subject” is normally a single person, such as a medical patient if the interest is therapeutic, an athlete if modeling sports, an employee when modeling ergonomics, a customer when modeling a useful product, etc. In some contexts it is useful to run a model to determine the effects of influences on a theoretical subject with particularly attributes, such as a subject that is a member of an identifiable class of subjects. In that case, the equations in the model can carry along statistical variables based on means and variances to which reference is made in interpreting the results obtained from the model.

“Data fitting” refers to methods for fitting components of the model of the subject (such as characteristics of the subject's knee joint or other joint or structure). In the case where model components concern, dimensions and shapes of anatomical features, clinical images such as MRI data can be segmented. A specific method of data fitting that has been described by the present inventors is called “host-mesh fitting” and is efficient for fitting an existing (generic) anatomical model to patient data. It embeds the generic model into a surrounding (‘host’) mesh and optimizes the mesh to minimize discrepancies between fiducial points in the generic model and their corresponding targets on the patient data.

An example of host-mesh fitting is shown in FIG. 4. A generic femur mesh is embedded in the host-mesh such that generic femur mesh deforms with the host-mesh when the host-mesh is deformed. The host-mesh is deformed by moving the host-mesh nodes. The host-mesh fitting process involves moving the host-mesh nodes such that the generic femur fiducial points are aligned with patient femur fiducial points. The resultant deformed generic mesh is the patient femur mesh. Note that the calculations required for host-mesh fitting may involve using a non-linear least-squares algorithm. An advantage of using a host-mesh is that it requires fewer nodes to be moved compared to the generic mesh, thus requiring less computational processing to perform the fit. The host-mesh also constrains the fitting process such that the general shape of the generic mesh is maintained.

Two common mesh fitting methods are surface fitting and host-mesh fitting. Surface fitting minimizes the least-squares error between the surface of the finite element mesh and the cloud of data points segmented from the MRI or CT scans. This is done by adjusting the positions of all nodes in the mesh defining the subject. This can be expensive because you have a large number of nodes and a large number of data points. Similarly, host-mesh fitting minimizes the least-squares error between the surface of the finite element mesh and the cloud of data points but in this case it is done by adjusting the positions of the nodes of the host-mesh. The internal mesh, e.g., a bone mesh, is deformed according to how the host-mesh is deformed because it is embedded in the host-mesh. The host-mesh has far less node point compared to the bone mesh. This means you can use less data points too. Making the whole fitting problem computationally cheaper. Also, host-mesh fitting maintains the general shape of the bone—it is not prone to large distortions which normal surface fitting is prone to. The disadvantage of host-mesh fitting compared to surface fitting is that it may not be as accurate. Other fitting methods are also possible.

The model preferably extends over nested small scale parameters (e.g., genetic or cellular) wherein the model defined relationships of parameters that produce values used as inputs for a larger scale aspect of the model. On the large scale side, the parameters extend to macro force and motion values, that are resolved as stresses that can be regarded in the model as influences to which the musculoskeletal structure or other anatomical structures adapt over time.

The respective models and model components advantageously describe the anatomy of the body's organs (including muscles, bones, tendons, ligaments & cartilage in the musculoskeletal system) with high order finite element basis functions. An example is a cubic-Hermite function. These allow an efficient description of the organ geometry and tissue anatomical structure (such as the fiber directions in skeletal muscle). The nodes of a finite element mesh can be encoded as location points (e.g., x, y, z coordinates relative to some reference), the interpolation between nodes, and other values such as the stress or orientation of fiber, coupled force, temperature, density, and similar parameter values. Although fitting surface meshes can be limited to geometry, it is also possible to fit other parameter values in an analogous way, provided that the parameters (for example, representing field values that vary with location) can be measured and/or inferred in an individual.

The use of high order basis functions allows the models to be customized with respect to inputs from image data (MRI, CT, surface scanning, etc) from an individual through a nonlinear least-squares fitting process known as “host-mesh fitting.” Comparable best-fit algorithms can be used for parameters such as the field parameters mentioned above (e.g., density, stress and strain and the like).

The computational methods are based on the laws of physics (e.g. conservation of mass, conservation of momentum, conservation of energy) and use constitutive laws that are to some extent biophysically based (e.g. based on the underlying tissue structure and multi-scale see below). As an example, the direction of trabecular plates and the local relative density (fraction of bone/total volume) can be used to calculate a directional modulus. This provides a non-isotropic description (transversely isotropic, orthotropic) for cancellous bone modulus,

The models characterize the anisotropy of tissue (different properties in different material directions), the nonlinear material behavior of tissues (e.g. the strain-hardening properties of soft tissue) and the inhomogeneity of all tissues (spatially varying properties).

The models are ‘multi-physics’, in that they often, for example, couple soft & hard tissue mechanics with computational fluid mechanics, vascular perfusion and neural modeling. In some cases the materials are also treated as multi-phase (e.g. a soft tissue may contain a solid phase and a fluid phase).

The models are ‘multi-scale’, in that they address multiple spatial scales, often from the level of whole organs or the whole body down to tissue, cell and subcellular pathways. A model dealing with the structure and function at one spatial scale is used to inform the parameters of a model at a lower and/or higher spatial scale, and has input from models at both higher and lower spatial scales.

The application of these principles to musculoskeletal modeling is important for certain applications where environmental factors (e.g., the activities engaged in or loads carried by a person) interact with genetic factors. Stresses transmitted down to cells can, via mechano-sensitive receptors and signal transduction pathways, lead to changes in gene expression and hence protein composition (determined by the balance between protein production and degradation) that then influences the material properties of the tissue.

Specific applications wherein the subject nested models encompass multiple natural phenomena (“multi-physics”) on a range of different dimensions (“multi-scale”) and are applicable to generate outputs for a patient-specific modeling of the musculoskeletal system include (without limitation) predictions as to how the engagement of an implant such as a graft or joint replacement element is expected to change over time. Modeling can assess how tissues in surgical repairs may become remodeled under the influence of altered stress distributions. This may involve the effects of altered muscle conditioning, scarring of tissues, tissue compaction and the like. Such predictions can assess the extent of improvements in material strength at surgical repairs, for example in a case where tissue grows into and incorporates tissue scaffolding materials (e.g., bone chips, etc.) used in correcting a birth defect or in filling or buttressing bones. A prediction may or may not lead to an assessment of an improvement where the specific patient conditions suggest that over time the tissue may degrade. For example, stresses could lead to loosening due to tissue compaction or other phenomena. Where there are alternatives such as different surgical changes, alternative graft and implant options, alternatives for recuperative exercise regimes such as occupational therapies, the modeling enables a comparison of how the expected outcomes might compare if different options are chosen or are applied for a longer or shorter time and in different sequences.

By modeling with multi-physics and multi-scale, assessments can take into account nano-scale phenomena such as gene expression leading to generation of proteins, biochemical effects of pharmaceutical intervention, mid-scale phenomena such as the alteration of vascular perfusion, and macro-scale phenomena, especially range of motion and mechanical strength and function (e.g., ambulatory function, sports capabilities and the like).

Modeling is useful to assess wear or deterioration that can be expected to occur in bones and joints and hence their lifetime. By way of example, osteoporosis is a disease in which loss of bone mass and hence bone strength (macroscopic properties) is a consequence of molecular level changes associated, for example, with calcium deficiency at a critical stage of development. The balance of osteoblast (cells that lay down bone material) activity versus osteoclast (cells that destroy bone material) activity is controlled by signal transduction pathways operating at the cell level that influence bone material properties and hence the ability of bones to support stress at the organ level.

In another example, the influence of exercise on muscle mass and type (fast versus slow twitch muscles) is an example of how organ level factors (the loads carried by muscle and their neural activation) can influence pathways that control gene expression within myocytes (muscle cells). The type of exercise (kinetic versus isometric) has a big influence on, for example, the relative expression of genes controlling the creation of mitochondria versus genes that control the creation of myofilaments.

With respect to the example of a method for predicting potential loosening of an element of an implanted joint, and associated joint wear, a typical scenario may be the replacement of a hip joint or knee joint by affixation of joint parts that may be installed by insertion into the lumen of the femur or affixed at the pelvis, formed and/or affixed at the tibia shelf, etc. In such situations, a three dimensional anatomically detailed model is defined for the muscles, bones, tendons, ligaments, cartilage, vasculature and neural pathways at the respective site (in this case the lower limb). The anatomical leg model is host-mesh fitted to surface data of an individual patient who needs a surgical implant, such as a replacement knee joint. The leg model might extend to external measurements from which other parameters are inferred. Preferably, medical imaging techniques such as magnetic resonance imaging or computer assisted tomography are employed to obtain detailed information including tissue dimensions, orientations of tissues such as muscle fiber, internal features such as vasculature and the like.

The model accounts for stress and strain distributions throughout the bones, muscles, tendons, ligaments and cartilage of a subject. By fitting the model to the individual's measured parameters, the model is made to account for the individual's structure and function. Whereas the model is embodied by mathematical equations, the measurements for the individual result in the adjustment of parameter values such as factors and constants that are included in the mesh fitted model, so as to represent the individual. The model is then run (the equations are solved). In the example of a leg joint, the model is solved, for example, with respect to the individual's gait cycle. The model, as customized to the individual, accounts for various loads such as the body weight of the person, aging and exercise, etc. The model is solved iteratively, over virtual time, and changes in the tissues are assessed.

Based on this patient-specific analysis, a suitable implant design can be tested, i.e., by solving and re-solving the model to assess stress and strain distributions during the gait cycle, integrated over time and exercise, wherein the stress and strain applied during earlier solution cycles are taken into account as input parameters affecting the individual's model for later cycles. The model is solved again with this feedback, and thus with iterative solutions, shows how tissue changes can be predicted to evolve as a consequence of that selected implant design.

Advantageously, the model can be operated with respect to different options for implant design that are incorporated into the leg model one at a time and solved iteratively to assess future changes that can be expected. By comparing predicted effects in the virtual world, options are compared and therapies can be accepted, rejected, timed and modified.

The stresses acting on the muscles, bones, tendons, ligaments and cartilage are transferred as boundary conditions to the various tissue models for detailed analysis of the stresses acting on cells via mechano-sensitive receptors that influence cellular signaling and gene regulation pathways.

The pathway models predict the changes in protein composition of the tissue (collagen; elastin, proteoglycans, etc.) and these are used via a mixture theory model to predict the effect on the tissue constitutive law. The updated constitutive law is used in the finite element biomechanics model and the above cycle is repeated.

The iterative computations may proceed to a point at which no further changes in tissue protein composition are projected (i.e., the iterative computations may converge). If so, at that point the model yields the likely wear acting at the joint surfaces and the strength of the mechanical coupling between the tissue and the implant. Convergence may project advancement of wear to the point of implant loosening, i.e., may indicate unacceptable failure. In that case, projections through time are useful to assist in the rejection or acceptance of that implant design and/or treatment regime. Alternatives can then be selected and tested in a similar way.

The invention generally concerns a method for assessing an anatomical structure preferably bones and joints but potentially including other anatomical structures and interactive systems that are subject to mathematical definition of inputs and outputs related by cause and effect, i.e., subject to modeling. The technique includes establishing a predictive mathematical model having associated parameters and interactions of parameters associated with biological tissues, wherein the model is applicable to predict changes in the biological tissues expected to result from application at least one influence, wherein the mathematical model embodies cause and effect relationships among the influence and the tissues. The technique further includes populating the model with data to define variable values of the parameters, wherein the variable values are specific to at least one of a biological subject and a group of biological subjects. The mathematical model is then exercised with respect to one or more defined such influences, and producing an output from the mathematical model based on the variable values used in populating the model, wherein the output comprises altered values for one or more of the variable values of the parameters as a result of the influence. By repopulating the model with said altered, values of the variable values and again exercising the model to assess results caused by the influence, the modeling is projected forward in time or forward over a number of instances in which the anatomical structure is exercised.

FIG. 5 is a general flow diagram showing how patient modeling and iterative solution of the model under changing influences results in a circular progression wherein the prediction model advances in virtual time.

Advantageously, the mathematical model comprises parameter values on a relatively smaller scale that result in tissue changes on a relatively larger scale. This range can extend from the micro scale of chemical or genetic reactions to the macro scale of joint motion and ambulatory gait. FIG. 6 illustrates a number of connections that can be taken into account over different dimensional scales, for different physical phenomena, and generally to model for iterations between variables and influences that have some cooperative effect but might be modeled as independent subsets (albeit less accurately).

The functions involved in the mathematical model can include assessment of tissue changes that are predicted as a function of at least one of an amplitude of the influence and a duration of the influence. In an exemplary application, the biological tissues comprise a musculoskeletal structure modeled to include interactions among at least two of bones, muscles, connective tissues comprising at least one of ligaments and tendons, surface defining tissues, introduced materials and externally affixed structures. However alternatively or additionally, the anatomical structure is modeled to include at least one of cellular, genetic, glandular, cardio-pulmonary, and vascular factors associated with influences associated with at least one of force, stress, motion, exercise, growth and aging.

Modeled influences may comprise, for example, surgical intervention, introduction of a pharmaceutical compound, introduction of a tissue scaffolding material, introduction of a structural member, and/or attachment of an exterior supportive structure. The effect of the influence may include wear on the tissues and/or change in the interaction with displacement of the tissues. A particularly apt application is to model for assessing the loosening of engagement of at least one inter-engaged tissues in the anatomical structure and an implant or brace or the like. To compare and assess alternatives, the physician can substitute conditions or alter at least one aspect of the influence and assessing the effect of the influence under altered conditions associated with the at least one aspect. Influence in this respect include at least physical exercise, weight and tissue growth, and further comprising determining the effect of the influence by integrating said influence over time.

In a practical example illustrating the invention, one can consider the scenario of a female patient suffering post-menopausal osteoporosis and the onset of osteoarthritis in the right knee. The knee (and possibly a larger portion of the patient including the knee) was recently scanned using MRI and/or CT scanning, and images are available in digitized form. Image processing software is applied to the scanned images, whereby with edge detection, contrast and similar attribute processing algorithms, the boundaries and preferably internal character of patient-specific organs are identified for insertion into a multi-organ model of the patient.

With reference to FIG. 1, individual organs and tissues (e.g. muscles, bones, ligaments) are segmented from the scan set in this way (2a). Library copies (2b) of generic stored organ models from a database (9) are fitted to the patient's organs using a method such as the host-mesh technique (2c), resulting in a set of difference values that can be used as input parameter values in models that are stored with respect to the generic stored organ models but are varied by the difference values derived from the patient measurements, such that the models are made specific to the patient when the patient's parameter values are input. This process is not limited to spatial shape and dimensions. For example, bone density as a function of three dimensional relative position can also be obtained from the CT scans (2c).

In addition to imaging data, parameter values can be obtained with respect to biochemical conditions by collecting blood and tissue samples. Some parameter values may simply require interviewing the patient. Some parameter values may involve aspects of the patient's medical history. Non-spatial parameters might include genetic DNA data, family history, patient history (accidents, prior history of disease), psychological assessment. Some of the input and output values represent variables and some are constants.

In the example of therapy for osteoporosis, the physician will wish to predict bone density at a future time. Porosity might be expected to advance with aging. On the other hand, therapeutic influences that may decrease porosity (increase bone density) might include pharmaceutical intervention or variations therein, stress/exercise therapy, and the like, to treat the condition. A cellular micro-model (2d) is employed to calculate predicted local changes in bone density architecture under 1) drug and 2) local stresses. It can be appreciated that in this example, local bone density is a given input condition obtained from the MRI or CT scan. Solving a model describing change in bone density resulting from the stress of exercise modifies local bone density expectations. The modified (expected) bone density information is then used to define new input conditions to the model (albeit the data is virtual projected bone density rather than being measured). The model is solved again based on the new input conditions. Over a period of iterative solutions with this feedback, changes in bone density are projected forward in time. This process is generally shown in FIG. 5, which diagrams the manner in which the tissue models can have inputs based, for example, on stress, coupled through the mechano-receptors signaling pathways (also modeled) to affect the protein composition of the tissues, and as likewise modeled using mixture theory and tissue constitutive laws, to affect the mechanical properties of the tissue. In the example of muscle tissue, the result may be stiffening or strengthening of muscles by addition of collagen or newly developed muscle fiber. Given the same level of exercise, the next iteration may predict a reduction in stress, and so forth. The situation subsequently modeled, and the predictions that the model produces, evolve by iteratively passing through this and similar iterative solutions of combined and connected component models.

The bone density data is locally specific, which is accomplished by encoding the density of incremental volume elements that are coupled to one another in a whole bone model. The exercise influence applies input parameter data on stress at the level of the joint, or perhaps the whole limb, but the bone simulation or model can transfer stresses on the joint or limb or bone to local stresses on the incremental volume elements. In this way, the model preferably incorporates variations in local density through the volume of the bone. Nested modeling of the, volume elements, the bone, the joint, the limb, etc. permits variables such as limb stress during walking, to be translated into local stress affecting local density in a bone as a separately simulated organ.

Modeling and iteratively repeating the modeling of a whole bone such as a femur under drug and exercise/stress influence, over a period of time, is useful for determining changes in local density. Moreover, the changes in local density can be applied to a model of bone function used in monitoring the density and potential for fracture at sites of common injury, such as the femoral neck.

The boundary conditions for the whole bone simulations are obtained from local joint forces obtained during a previous simulation (5) of the combined model (4). The density, mechanical properties and shape of her bone models are updated (2e) Mechanical data for remodeled (iteratively solved) whole bones is re-calculated in each iteration. The parameters defining the model bones are updated (2), thereby predicting how the parameters evolve under the defined influences. The model (4) is run again (5) under the evolved parameters, and so on.

In the foregoing example, the influences are impliedly defined and fixed at the outset (pharmaceutical intervention and exercise). However, the influences can be monitored and measured as variables as well, to better refine the model. Thus, for example, a log of actual exercise time and type can be produced to define a time-changing influence. The physician may wish to investigate the effectiveness of changes over the time the model is solved, for example by fitting a virtual knee brace to the right knee. In this instance a virtual brace model (3) is added as a contributing part of the leg model and run in a combined model (4) that is responsive to the new (braced) conditions during the iterations when the virtual brace is to be mounted. One clinical pathology is osteoarthritis of the knee. We have chosen to introduce various variables and then analyze the knee and produce hard data biomechanical outputs.

The invention can be considered with respect to the treatment of osteoarthritis of the knee. This condition most commonly involves the medial compartment of the knee but in about 15% of patients it also involves the lateral compartment. The basic pathology involves the wearing out of the articular cartilage on the tibial surfaces within these compartments. It is generally accepted that the process is accelerated by the presence or absence of menisci or by knee instability such as occurs with ACL injury. It is generally accepted that weight gain accelerates the disease process by increasing load on the articular surface. It is generally accepted that alterations in the skeletal angles of the tibial plateau affect the respective loading in individual compartments as well as the nature of the movement that occurs between the articulating surfaces during the weight bearing phase of gait. It is generally accepted that the larger the varus or valgus angle the greater the degree of tibial rotation that occurs between the articulating surfaces.

The foregoing characteristics are embodied in an exemplary model by producing at least a simplistic index of articular cartilage wear. This index can define, for example, a load parameter x related to articular surface contact which load factor may be related to contact surface areas and pressures, degree of movement (rotation and translation) during the gait cycle. The load can be modeled as varying with the weight of the patient and the proportionate compartmental load (other things being equal). The degree of articular surface contact under load is determined by the articular surface contact during a gait cycle, namely from structural surface contours. Wear, as an output, is determined by solving for factors including the load, contact, and the surface area across which that load is borne.

There are many variables which could be added to better define the model. These include, without limitation, the nature of the articular cartilage, density, osteochondritis, etc.; the nature of the synovial fluid; the specific geometry of the articular surface; the rate of change of varus or valgus angle with time or number of gait cycles, i.e., the effect of disproportionate load bearing over time. As the disease progresses the angle increases, thus increasing the disproportionate load, thus accelerating the wear. The specific data outputs from this stage include solved variable values such as the load in each compartment for a given individual, leading to wear.

The mathematically modeled relationships include the extent of the articular surface contact and the loading. But the components applicable to the contact calculation include rotation, surface area, etc., and also define what is the impact of increasing varus/valgus angle on load in each compartment, how load may differ with increased or decreased weight.

There are alternative modeling relationships possible, for example by modeling how varying the weight and/or the angle affects the “wear index,” as opposed to proceeding through the smaller scale of assessing the local pressure and associated wear. However the presence or absence of menisci also have an effect on wear, presumably menisci reduce contact.

As wear persists and increases, the variables defining the original input conditions such as the nature of the articular cartilage, are altered by wear, to a degree that is likewise modeled. The altered conditions become applicable as the model is solved, resulting in further altered conditions by which progress of the disease is virtually modeled over successive iterations that might be run a longer or shorter time, e.g., weeks, months, years, decades.

As discussed, the technique can be applied to include the modeled effects of grafts, braces and the like. Assuming for purposed of illustration, a knee brace may comprise a central hinge located at the knee joint line. From each hinge center, brace arms extend up the femur and down the tibia to or along an area of structural attachment. Typically contact plates attached to the knee brace arms lie against soft tissue above and below the knee. The nature of the soft tissue varies the particular way in which forces are coupled to the tibia or femur via the contact plates. That is, the knee brace is attached at soft tissue but is intended to support and to limit the freedom of motion of the underlying skeleton. The femoral portion of the knee brace fits the patient's soft tissue profile while stabilizing the hinge centers and the tibial portion below. It also provides the lever arm so that the tibial portion of the brace can exert a desired effect such as varus or valgus “push or pull” which depends on whether they are applied medially or laterally.

The hinge arms have offsets above and below the hinge centers and these are adjusted to fit the patients contour and then to exert the desired force on the tibia. The offsets may be adjustable, to allow for the degree to which the application plates “sink into” the soft tissue against which the knee brace is applied.

The knee brace is modeled according to the invention, as if the knee brace was another natural element of the knee. Therefore, starting with a model of the knee, the standard configuration knee brace which has known offsets and application areas is imported. Force absorption of the soft tissue is assessed as a soft tissue index which is validated by area. (For example, absorption on the medial side of the thigh is greater than on the lateral side.)

When fitting the brace, the offsets are adjusted to make the brace fit snugly, taking into account the soft tissue absorption. The tibial offsets are then altered to exert a varus or valgus force on the tibia. It is then possible to compute assumed benefits of the force, including two components, namely an assumed reduction in compartmental load, and an assumed reduction in degree of articular surface contact as a result of reduced tibial rotation.

The pertinent model parameter input values and solved variable data outputs include those required for the baseline knee analysis and also for various tibial offsets so that an optimal brace configuration might be determined. It would be beneficial to be able to vary the femoral offsets as well but in the first instance these would be altered from the standard specification in order to achieve fit against the patient profile (index for soft tissue density.

One form of output may be the force resisting the brace action for any given individual so that a brace specification can be demonstrated to be effective. At present hinge arms are not varied by load and it is logical to do so and to prove efficacy. Similarly it is logical to determine the optimal area or at least a choice of several sizes for application plates so as to minimize the “soft tissue density” impact.

A high tibial osteotomy is a common operation whereby the tibia (and often the opposed femur) is trimmed and then reunited with opposed counterpart so that the anatomical angles are varied. The objective is to slow the progress of osteoarthritis in the knee, which is a progressive deterioration. The operation is designed to minimize the “wear index” by “unloading the effected compartment”. The biomechanical benefits to the worn compartment include a reduction in load, and reduced contact area per gait cycle (reduced rotation, etc.).

Preoperative analysis of the articular surfaces radiologically is a known technique for planning a surgical intervention. The medial lateral plane and the antero posterior plane are considered, using two or more two dimensional images. A wedge is of bone is to be removed. The shape of the desired wedge is multiplanar but principally targets correction of any varus or valgus deformity at the knee and is achieved by removing a tibial wedge.

The application of the inventive model in this case is to quantify the biomechanical benefits of these procedures in terms of wear index and the variables that contribute to it, and in that way to assess outcomes by assessing optional specific procedural details and projecting a prediction of how the tissues will react and adapt to the changes. According to the invention, a surgeon who might generally ponder an optimal anatomical angle while examining radiological images, can instead (or in addition) perform a virtual procedure, project its effects into the future, and obtain specific projected biomechanical and “wear index data” to quantify the predicted benefits of a proposed procedure.

Iteratively solving the model while adjusting the input conditions at each iteration, to reflect the outcome of the previous iteration, enables tissue adaptation and wear to be modeled over time, with the corresponding ability to examine the effects of related variables such as changing body weight, exercise or the like. Effects can be modeled over time or by occurrence, such as modeling with patient aging or as a function of the number of gait cycles allowing for variations with the extent of projected use of the knee. Data outputs can be produced and compared for a baseline analysis, and also for various alternative virtual procedures and recovery regimes, and over a longer or shorter period of use.

Total knee replacement is an increasingly common procedure that is similar subject to application of the invention. With increasing life spans, and with decreased activity levels and increased body weight associated with aging, total knee replacement is not only increasingly common, but there is a more frequent need for surgical intervention to revise the surgical results (to do it again).

A weak link in total knee replacement procedures is the tibial component, which sometimes becomes loose due to stress-related remodeling of the bone beneath it. The stress relationship that is modeled can be subtle. For example, the remodeling of bone that leads to loosening can be due to too little load from the implant, not due to excessive load. In any event, the tibial bone is remodeled and can loosen where the implant is in contact, which can be a relatively small bone structure even after the initial surgery. When revision surgery is to occur, there is less bone structure available to receive and support the tibial implant. Wear can produce a leg length discrepancy which must be corrected, potentially by revision surgery. Sometimes as the tibial component becomes loose, the knee joint falls into varus which accelerates the process of loosening.

Modeling according to the invention applies and assists in various aspects of this procedure and is useful to optimize the clinical outcome for any given individual by predicting the likely outcome of alternative implant structures and procedural steps before they are undertaken. The modeling can be combined with a virtual population group to provide the capability of statistical assessments in an implant design and virtual trial tool.

Similar to the technique of modeling the combination of a knee and a knee brace, modeling for a total knee replacement, or for a tibial insert thereof, first involves a baseline analysis to model the preoperative knee, and incorporation into the model of the structure of the proposed implant. The Model can be operated to assess hard biomechanical aspects and wear as model outputs. The model can be arranged to incorporate alternative starting conditions and alternatives of medication and exercise.

Some specific outputs useful for total knee replacement include sizing of the implant relative to the patient, customization of implant for an individual patient, customization of the implant to selectively optimize articular surface shape, selection of implant structure and/or orientation to control stress at the bone-implant interface (i.e., to minimize exposure to loosening), and selection among alternative materials.

Up to this point, modeling according to the invention has related to the joint at issue, such as the joint, and to artificial grafts, implants or supports directly associated with the joint. According to another aspect, the invention enables modeling to predict tissue adaptation to changes that may be less directly associated with the joint. For example, by nesting and modeling intervening structures interactively, the effects of a change at one point, such as any change affecting gait or posture, can be related to the knee. Notably, by modeling the entire leg, the effects of employing a wedge orthotic at the foot can be related to changes in compartment loading at the knee, and used to predict the resulting wear on the knee joint over time.

In other examples, the physician might wish to implant cartilage tissue scaffolds in the patient's knee to affect the modeling of the joint, the input parameter values and/or the iteratively fed-back values at a selected point in time. The software allows the physician virtually to resurface the bone's joint surface (i.e., to remove some eburnated bone in the virtual modeling) to provide a site for virtually modeled scaffold material to be placed (2f). A model of the scaffold is employed (3). The material properties of the scaffold are encoded into the model. With the scaffold placed at the bone site (in the virtual model) iteratively solving the combined model (4) enables the physician to assess and in an embodiment with graphic display output to visualize, the evolving changes in the tissues as they adapt to these conditions. In one or another such predictive cycle, depending on conditions, the bone may heal and incorporate the (resorbable) scaffold. If the scaffold was used to mechanically affix a joint element, the strength of the joint may be improved in this manner. In another scenario, for example with less than optimal conditions and exercise, the model may predict that the joint element will become loose and fail. In these examples, macro forces are modeled to encode joint or bone stress; organ models such as modeled muscular action can equate exercise to stress applied to bones (e.g., running or treadmill or step exercise); organ models such as bone models translate linear shock, torque, bending stress and the like to a distribution of local volume stresses; local bone density models relate the amplitude and duration of stress to increased bone density (at least up to a point short of damaging levels of stress). Thus, cell/tissue micro-models (2d) are used to predict evolving tissue structures that iteratively remodel of the joint as the model is repetitively solved.

In another example, a physician may wish to investigate the projected (predicted) results of a staged procedure of osteotomy followed by tissue engineering, and moreover to examine how recovery can be expected to proceed over time. For example, the patient's left tibial plateau may need to be repositioned to adjust for an aspect of gait. The physician runs a model in virtual space, starting with a customized representation of the patient based on the generic model, and including altering the bone model (2f) according to the proposed operation and subsequent therapy. The new virtual tibia is incorporated in the combined model and the corresponding forces are calculated across the joint. The physician can repeat the procedure to explore a second stage of tissue engineering, e.g., scaffold material insertion, to advance joint reconstruction and healing, all in a virtual projection.

At the end of each simulation a new patient record can be generated (6) to define the projected state of the patient's recovery. During modeling, the physician can try different influences and test the results. After actually undertaking the therapy, the physician can compare the patient results with the prediction from the model and perhaps update the prescription (7) or otherwise alter the therapeutic regime as appropriate. In assessing progress towards recovery, each patient record at follow-up can be compared with a previous prediction.

The actual experience achieved by a real life patient and the outcome that results are preferably added as records in a database (8), from which the generic models of patients or joints or bones is derived. Thus, selected information from actual patient data such as bone geometry is added to fill out and refined the population database (9). The population database (9) is useful for providing new generic models and for fine tuning remodeling algorithms. The population database is also useful in assessing therapeutic regimes and outcomes in a statistical sense to make diagnosis and treatment more accurate and effective. In this way, the nested iterative models as described are useful clinically to assist in the planning and execution of therapies for particular patients, and useful generally to influence management decisions about diagnosis and therapy decisions that are to be recommended in general.

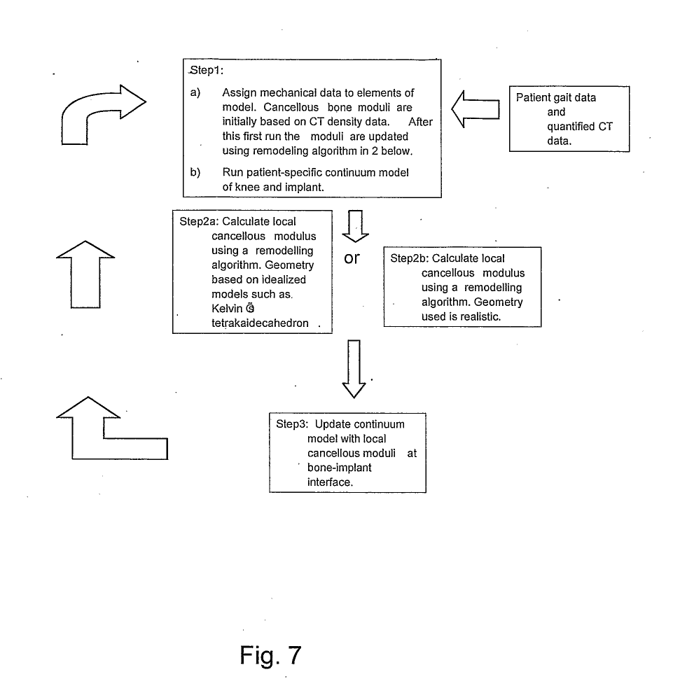

It is advantageous to apply the invention to modeling joint replacements because coupling a prosthetic element to natural bone in a surgical intervention has the effect of redistributing stresses, such as stresses that occur from walking (gait). Stress or lack of stress applied to bone is a parameter that affects bone density and if stress patterns are changed, bone density patterns change as well. In the case of a total knee replacement, for example, one can apply a patient-specific customization of a generic model of the whole knee. Aspects of modeling in this scenario are illustrated in FIG. 7.

The model includes ligaments, tendons with muscles attached and a prosthetic knee joint coupled to natural bones. These elements are modeled for their size, shape, density, composition and position, the points of their attachment, their elastic properties, their cellular function and so forth. In order to examine the stress distributions and to project the effect of a total knee replacement, stress loading data is generated from the actual way the person walks. Pertinent parameters might include statistics on the number of steps taken in a day while walking or running or climbing steps.

A continuum model is provided to determine the structural distribution of stress loading through the interconnected structural elements. A coarse solution, for example, can integrate the amplitude over time for stress loading, as well as the local direction and level of stress in a continuum around the implant and bone, to scale, for example, of a centimeter. Cancellous bone is treated as a structure in the continuum and has a density property, a stress bearing capacity, and a localized response to stress over time

One might be interested in predictive modeling of the adaptive changes in bone density under the tibial tray of a proposed or already-implanted knee prosthesis. A modulus of elasticity value can be calculated from a look-up table that relates local bone mineral density (related to CT number) to an equivalent Young's modulus. This value can be determined for each incremental volume element in the continuum.

In an area of interest, such as the bone volume along the tibial tray underside, incremental volumes that have an edge length of 4 mm, for example, are defined and treated as discrete sub-model units. This edge length is chosen because a continuum assumption for cancellous bone breaks down at length scales only several trabeculae long; and the typical mechanical cell size for cancellous bone is about 0.8 mm.

Scan data for these sub-model units can be used to calculate trabecular architectural parameters such as trabecular spacing, relative density, and mean trabecular thickness. The interface geometry between the prosthesis and the bone can be regarded as a rigid boundary at which force is applied to the bone.

The foregoing parameters represent a model defining the structures of the joint elements, and influences including a 3D field of applied stress. At the sub-model unit level, a function is applied whereby integrated stress loading is predicted to cause an incremental change in density over an assumed incremental time. This prediction can employ an idealized architecture based on a 3D repeating ideal geometry (perhaps Kelvin's tetrakaidecahedron). The idealized architecture can be tailored to use parameters (e.g., plate spacing, relative density, etc.), also used for the bone. The boundary conditions on the sub-model units can be obtained from the stress field calculations mentioned above. Next, for each sub-model unit, a local adaptive response is calculated, resulting in an incremental change (“re-modeling”) of the sub-model units due to the stress or lack thereof. The precise calculation can be according to an average stress parameter value determined from local strain energy density or an equivalent stress, multiplied by a number of steps taken in a day and taking into account changeable factors such as body weight, etc. The factors used can be determined empirically or can be determined or refined where possible from the outputs of other connected model calculations. Non-mechanical influences such as genetic influences, sensitivity to wear debris and drug therapies can be taken into account as well.

The model is such that stress levels above and below some threshold may be predictors for increase or decrease in density. More particularly, the solution of the model for each incremental time recalculates predicted trabecular parameters (e.g., spacing, mean thickness, relative density, etc.) at each modeled sub-unit. The solution adjusts the local bone density due to influences occurring during the incremental time. The cooperation of the modeled sub-units, which are treated as connected structural blocks, together define a density continuum modulus over a larger scale, at least on the scale of the joint.

As an alternative (step 2b in FIG. 7), the sub-unit models can comprise further subdivisions. In one embodiment, the detailed trabecular architecture can be modeled, subjected to distributed stress by virtual predictive modeling according to the invention to incrementally alter and redefine the model for each cancellous plate within the volume of interest of each sub-model, and the process can be carried forward iteratively to predict how these structures will adapt and evolve under the influence of applied stress. By modeling to this more detailed structural architecture (to the trabecular level), stresses can be modeled and densities adjusted to a scale of tens of microns.

At FIG. 7, step 3, the virtually-revised predicted trabecular parameters (Step 2a) and/or revised detailed cancellous architecture (Step 2b) are useful to update the model of larger scale structures proceeding to the bone and implant; the joint, and the subject's gait. The stress distribution situation in this virtually-modeled biomechanical system has thus been altered to reflect predicted changes. In the next iterative solution of the model, the process continues and the model evolves incrementally into the virtual future. Specifically the model is updated with recalculated cancellous density values, which via a look up table produce modulus field values, and by finite element calculations enable the localized values to be interpreted with respect to the larger model.

Of particular interest in connection with joint replacements, the distribution of stresses in a continuum field comprising the bone around the implant is of particular interest. At this point, adaptive changes in the bone corresponding to local variations in applied stress can lead to loosening that may require further surgical intervention. Modeling the structures and predicting changes are useful to assess and proactively address the effects of stress and other influences.

As further benefits, patients can be involved in and review the results of modeling, e.g., volunteering information about lifestyle and committing or not committing to potentially demanding therapies, e.g., involving an exercise regime and/or body weight management. Patients who understand their problems fully and appreciate the natural history and likely progress of their condition, can expect to achieve improved outcomes and are likely to commit to treatments and recovery regimes that are as conservative or as demanding as the patient believes they can bear, knowing what is involved.

Prescribing surgeons likewise can make more informed decisions as to the timing of intervention, whether conservative or surgical. The results of intervention can be expected to increase in accuracy and sophistication as the population database grows and the results are studied whereby correlations can be identified leading to additional models and consideration of previously unrecognized causal factors in models that are iteratively solved.

The invention enjoys substantial advantages over the current state of affairs, wherein physician experience and judgment are relied upon with out a comparable ability to define and virtually attempt and project different options. In the present world, diagnosis and assessment of alternative therapies are based on a matrix including clinical symptoms, radiological appearances, and often arthroscopic assessment and ongoing clinical observation. Analysis of biomechanical factors over multi-scale and multi-physical considerations is not applied, although it might be inferred that the operation of a biomechanical unit such as a joint must be related to the operation of the included structures.

The invention has been disclosed with respect to a number of exemplary embodiments and applications. It should be understood that the invention is not limited to these examples and is subject to embodiment in additional ways according to the appended claims.

What is claimed is:

1. A method for subject-specific modeling of biological structure and function, comprising the steps of:
establishing a predictive mathematical model representing physical and functional parameters and interactions of the parameters, the parameters being associated with biological tissues, wherein the model is applicable to predict changes in said biological tissues expected to result from application of at least one influence, wherein the mathematical model embodies cause and effect relationships among the influence and the tissues;
populating the model with data to define variable values of the parameters, wherein the variable values are specific to at least one of a biological subject and a group of biological subjects;
exercising the mathematical model with respect to a defined said influence, and producing an output from the mathematical model based on the variable values used in populating the model, wherein the output comprises altered values for one or more of the variable values of the parameters as a result of the influence;
repopulating the model and again exercising the model to assess results caused by the influence.

2. The method of claim 1, wherein at least one of the variable values of the parameters is initially defined as a starting value and is altered by said exercising of the mathematical model producing an output, and wherein said repopulating of the model comprises replacing the starting value a new value based at least partly on the output.

3. The method of claim 1, wherein the mathematical model comprises parameter values on a relatively smaller scale that result in tissue changes on a relatively larger scale.

4. The method of claim 3, wherein the mathematical model comprises parameter values on a micro scale that result in tissue changes on a macro scale.

5. The method of claim 1 wherein the mathematical model comprises assessment of resulting tissue changes as a function of at least one of an amplitude of the influence and a duration of the influence.

6. The method of claim 1, wherein the biological tissues comprise a musculoskeletal structure modeled to include at least part of one of bone, muscle, connective tissue comprising at least one of cartilage, ligaments and tendons, surface-defining tissue, introduced material, and externally-affixed structure.

7. The method of claim 6, wherein the anatomical structure is modeled to include at least one of cellular, genetic, glandular, cardio-pulmonary, and vascular factors associated with influences associated with at least one of force, stress, motion, exercise, growth and aging.

8. The method of claim 6, wherein the mathematical model comprises parameter values of one biological organ that result in tissue changes in another biological organ.

9. The method of claim 1, wherein the influence comprises at least one of a surgical intervention, introduction of a pharmaceutical compound, introduction of a tissue scaffolding material, introduction of a structural member, and attachment or engagement of an exterior supportive structure.

10. The method of claim 6, wherein the effect of the influence comprises at least one of wear on the tissues and change in the interaction with displacement of the tissues.

11. The method of claim 10, wherein the effect of the influence comprises loosening of engagement of at least one inter-engaged tissues in the anatomical structure and the orthosis with said tissues in the anatomical structure.

12. The method of claim 10, further comprising altering at least one aspect of the influence and assessing the effect of the influence under altered conditions associated with the at least one aspect.

13. The method of claim 7, wherein the influence comprises at least one of physical exercise, physiotherapy, weight, diet, tissue growth, adjustment of gait and disease state, and further comprising determining the effect of the influence by integrating said influence over time.

14. The method of claim 1, further comprising repopulating and exercising the model to represent changes caused by the influence over a period of time.

15. The method of claim 1, wherein the biological tissues comprise at least one bone, wherein the influence comprises at least one of force, stress, physical exercise, pharmacological intervention, structural variations in an implant, and addition of orthotic support.

16. The method of claim 15, further comprising varying at least one of the parameters and interactions, exercising the model using the parameters and interactions as thus varied, and comparing the results.

17. The method of claim 15, further comprising varying at least one of the parameters and interactions while repopulating and exercising the model.

18. The method of claim 1, wherein the biological tissues comprise at least two bones connected by associated connective tissue at a joint and subject to movement by contraction of associated muscles, wherein the influence comprises force and stress produced by physical motion, and wherein the results comprise a change in at least one of the configuration and material properties of at least one of the bones, muscles and connective tissues.

19. The method of claim 18, further comprising exercising the model under at least one alternative circumstance and comparing the results under said alternative circumstances, and wherein alternative said circumstances comprise variations in at least one of pharmaceutical intervention, choice of surgical procedures, configurations of at least one implant, additional support of one of an orthosis and an external brace, variations in configurations of one of an orthosis and brace, and variations in a regime of at least one of physical exercise, diet, weight and lifestyle.
